(19) United States
(12) Patent Application Publication
(10) Pub. No.: US 2011/0225806 A1
(43) Pub. Date: Sep. 22, 2011

(54) APPARATUS AND MANUFACTURING PROCESS FOR AN ELECTRICAL MACHINE

(75) Inventors: Stephen Knight, Billericay (GB); Mike Dowsett, Essex (GB); Toby Heason, Leicestershire (GB)

(73) Assignee: Controlled Power Technologies, Ltd.

(21) Appl. No.: 13/063,390

(22) PCT Filed: Aug. 27, 2009
(86) PCT No.: PCT/GB09/51076

§ 371 Date: May 19, 2011

(30) Foreign Application Priority Data
Sep. 12, 2008 (GB) 0816712.4

(51) Int. Cl. H02K 15/02

(52) U.S. Cl. 29/596

(57) ABSTRACT

A method of, and apparatus for, manufacturing an electrical machine such as an integrated starter generator, the method comprising a double hot drop operation, whereby a stator assembly is inserted into a steel sleeve after the sleeve has been heated, and the stator assembly and sleeve are subsequently cooled and inserted into a heated housing.

### CROSS-REFERENCE TO RELATED APPLICATIONS

The present application claims priority to International Application No. PCT/GB2009/051076 filed on Aug. 27, 2009, which claims priority to Great Britain Patent Application No. 0816712.4 filed on Sep. 12, 2008.

### STATEMENT RE: FEDERALLY SPONSORED RESEARCH/DEVELOPMENT

Not Applicable

### BACKGROUND OF THE INVENTION

This invention relates to a method of manufacture of an electrical machine. In particular the invention relates to an apparatus and manufacturing process for electrical machine such as an integrated starter generator (ISG), which is capable of switching from a starter motor mode to an alternator or generator mode.

A known method of assembly of electrical machine components is cold pressing. However, cold pressing of components together usually causes damage, such as heavy scuffing, to the components, particularly when a heavy interference fit is required between the components. The electromagnetic properties of the components, and the stack density, can also be detrimentally altered by cold pressing operations. Furthermore, very high forces are required to assemble the components by cold pressing when a heavy interference fit is required.

### BRIEF SUMMARY OF THE INVENTION

It is an object of the present invention to provide an apparatus for, and a method of manufacturing an electrical machine which provides a sufficient degree of interference fit between the assembled components, to prevent their separation at high temperatures, without causing damage to the components, and wherein the specific stack density of the components can be maintained.

Accordingly, the present invention provides, in one aspect, a method of manufacturing an electrical machine, the electrical machine comprising a stator assembly, a sleeve, and a housing, the method comprising a plurality of hot drop operations, wherein the hot drop operations comprise a first hot drop operation wherein the sleeve is heated prior to insertion of the stator assembly into the sleeve, and a second hot drop operation wherein the housing is heated prior to insertion of the stator assembly and sleeve into the housing, wherein between the first hot drop operation and the second hot drop operation, the stator assembly and sleeve are allowed to cool.

The sleeve may be formed of stainless steel, or alternatively medium/high carbon steel which has been electroplated. The housing may comprise a die casting formed of aluminum. The electrical machine may be an integrated starter generator, or any other switched reluctance machine used in high temperature applications.

At least one of the hot drop operations may comprise an inductive heating step.

The method may include an additional step of locating a cooling jacket between the sleeve and the housing.

### BRIEF DESCRIPTION OF THE DRAWINGS

An embodiment of the present invention will now be described by way of example and with reference to the accompanying drawings in which:

FIG. 1 is a front view of an electrical machine comprising an ISG, manufactured by a method in accordance with the present invention;

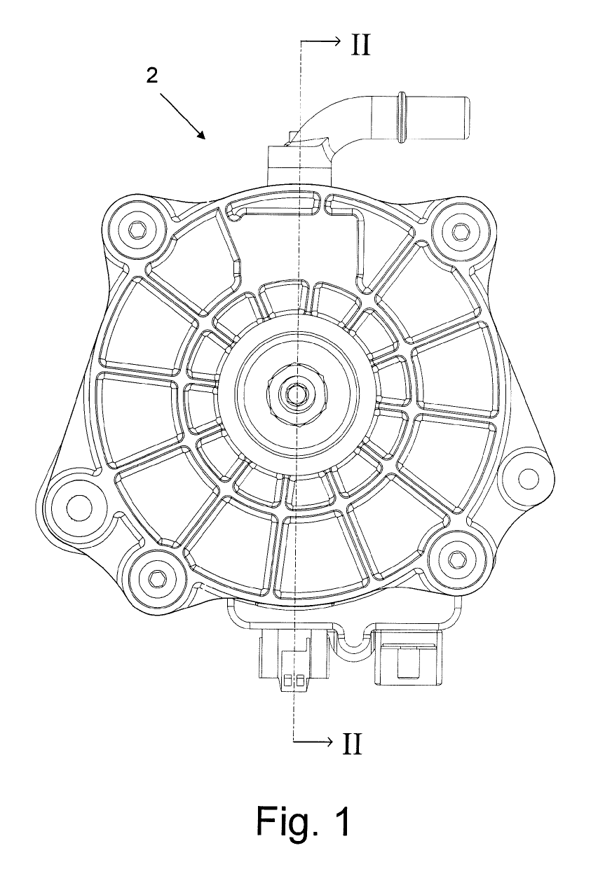

FIG. 2 is a cross-sectional view of the ISG of FIG. 1 along the line II-II; and

FIG. 3 is a detailed cross-sectional view of the ISG of FIG. 2.

### DETAILED DESCRIPTION OF THE INVENTION

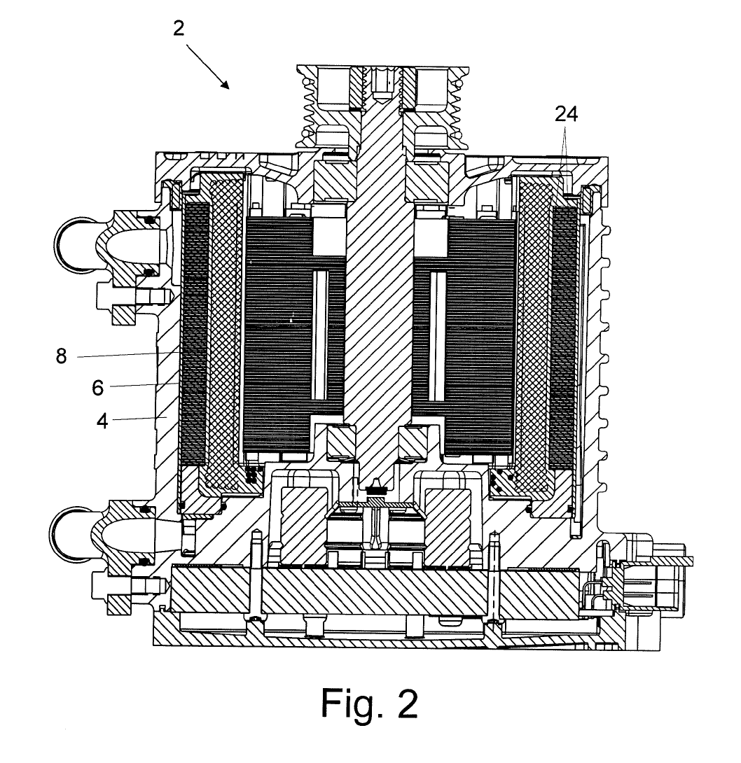

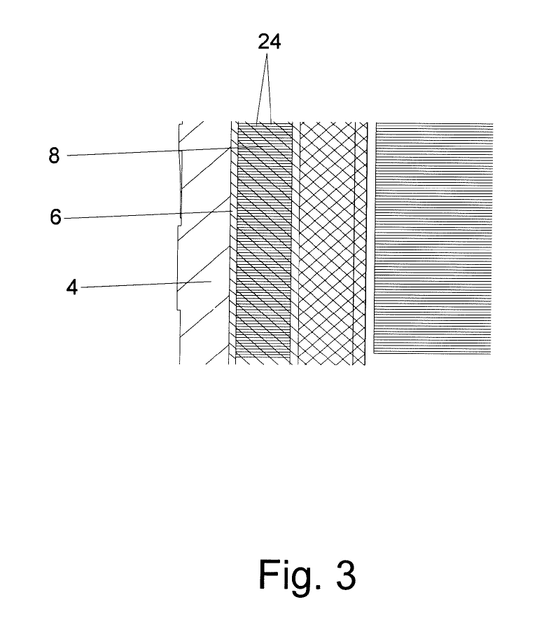

FIGS. 2 and 3 illustrate an ISG 2 comprising a steel sleeve 6, a stator assembly 8, and main motor housing comprising an aluminum die casting 4. The stator assembly 8 is formed of a plurality of laminations 24 formed of a magnetically permeable material, coated with a non-electrically conductive coating such as a lacquer. The laminations 24 are layered on top of one another in a stack arrangement, with a small gap between each layer.

The number of laminations 24 in the stator assembly 8 is chosen to provide an predetermined stack density, i.e. an optimum number of laminations 24 per unit length.

The outer diameter of the stator assembly 8 is greater than the inner diameter of the sleeve 6, to provide an interference fit after assembly of these components. Similarly the maximum outer diameter of the sleeve 6 is greater than the inner diameter of the die casting 4, to provide an interference fit between these components after assembly.

The manufacture of the ISG comprises formation of the stator assembly 8, formation of the sleeve 6, and formation of the die casting 4. The components are then assembled by a first hot drop operation to insert the stator assembly 8 into the sleeve 6 to form a sub-assembly (not shown separately in the figures), and a second hot drop operation to insert the sub-assembly into the die casting 4.

The first hot drop operation involves using heating means to heat the sleeve 6 to 200° C. The heating means comprises an inductive heating element (not shown) onto which the sleeve 6 is placed. Adhesive is then applied to the areas of the outer diameter of the stator assembly 8 which will be in contact with the sleeve 6 after assembly. The stator assembly 8 is then inserted into the heated sleeve 6. As a result of being heated, the sleeve 6 has expanded, thereby causing an increase in its inner diameter relative to its value at ambient temperature. Accordingly the force which is required to insert the stator assembly 8 into the sleeve 6 is much lower than if the components had not been heated.

Prior to the second hot drop operation, the sub-assembly (comprising the stator assembly 8 and the sleeve 6), is allowed to cool. The second hot drop operation is then achieved by using heating means to heat the die casting 4 to a temperature of 140° C. The heating means again comprises an inductive heating element (not shown), and then inserting the sub-assembly into the die casting 4. The sub-assembly is inserted into the die casting 4 in a predetermined orientation so as to ensure insertion phase windings provided on the stator assembly 8 are inserted correctly into corresponding apertures 14 in the base 16 of the die casting 4.

A press tool is used to insert the sub-assembly comprising the stator assembly 8 and the sleeve 6 into the die casting 4. A force of 3000N is required to complete the insertion, however, as explained above, this force is much lower than the force which would be required if the components had not been subject to the heating and cooling to reduce the differential between the maximum outer diameter of the sleeve 6 and the inner diameter of the die casting 4 compared to the differential when the components are at ambient temperatures.

After insertion of the sub-assembly into the die casting 4, the assembled ISG is left to cool.

Operating speeds of the ISG can reach up to 22,000 rpm. On operation of the ISG, high electrical loading on the ISG will cause the stator assembly 8 to become heated, therefore also causing the sleeve 6 and die casting 4 to become heated and expand. The aluminum die casting 4 will be caused to expand to a greater extent than the steel sleeve 6 due to aluminum having a higher coefficient of thermal expansion than steel. The interference fits between the components will ensure that in their expanded states, the die casting 4 and the sleeve 6 will not separate.

The present invention also avoids potential detrimental effects on the electromagnetic properties of the components which would be likely to occur if the components were to be assembled by cold pressing operations. Furthermore, if cold pressing operations were to be used to assemble the components, the considerable forces which would be required to complete the assembly would be likely to cause the stator laminations 24 to plastically deform, therefore causing a potential variation in the density of the stator stack, i.e. the stack density could be caused to vary from the predetermined optimum value.

The present invention also avoids potential damage to the coating of the stator laminations 24 which could occur if cold pressing operations were used. If considerable pressing forces, and/or plastic deformation involved in cold pressing operations, could be caused to squeeze the stack together, thereby reducing the gap between each the layers of stator laminations 24. If the gap between two adjacent layers is reduced sufficiently that the laminations 24 become in contact with one another, the coating of the laminations 24 could be caused to wear away at a particular point on each lamination 24, therefore creating an electrically conductive path between the laminations 24 at this point. This would result in the formation of eddy currents within the stator assembly 8, which would result in electrical performance losses.

Suitable materials for the steel sleeve are stainless steel, or a medium/high carbon steel which has been electroplated.

In an alternative embodiment, a cooling jacket may be located between the sleeve 6 and the die casting 4.

Although the embodiment described above relates to an ISG, the present invention is applicable to other switched reluctance machines, such as a turbo generators.

1-14. (canceled)

15. A method of manufacturing an electrical machine, the electrical machine comprising a stator assembly, a sleeve, and a housing, the method comprising a plurality of hot drop operations;
wherein the hot drop operations comprise a first hot drop operation wherein the sleeve is heated prior to insertion of the stator assembly into the sleeve, and a second hot drop operation wherein the housing is heated prior to insertion of the stator assembly and sleeve into the housing, wherein between the first hot drop operation and the second hot drop operation, the stator assembly and sleeve are allowed to cool.

16. The method as claimed in claim 15 wherein at least one of the hot drop operations is performed at 140° C.

17. The method as claimed in claim 15 wherein at least one of the hot drop operations is performed at 200° C.

18. The method as claimed in claim 16 wherein at least one of the hot drop operations is performed at 200° C.

19. The method as claimed in claim 15 wherein the sleeve is formed of stainless steel.

20. The method as claimed in claim 15 wherein the sleeve is formed of medium or high carbon steel and wherein the sleeve has been electroplated.

21. The method as claimed in claim 15 wherein the housing comprises a die casting formed of aluminium.

22. The method as claimed in claim 15 wherein the electrical machine is a switched reluctance machine.

23. The method as claimed in claim 15 wherein the electrical machine is an integrated starter generator.

24. The method as claimed in claim 15 wherein at least one of the hot drop operations comprises an inductive heating step.

25. The method as claimed in claim 15 including an additional step of locating a cooling jacket between the sleeve and the housing.
